(19) United States
(12) Patent Application Publication
(10) Pub. No.: US 2002/0170189 A1
(43) Pub. Date: Nov. 21, 2002

(54) Door jamb alignment apparatus

(76) Inventor: Thomas E. Cheatham, Mt. Washington, KY (US)

Correspondence Address: Michael A. Painter, Suite 850, 8484 Wilshire Boulevard, Beverly Hills, CA, 90211, US

(21) Appl. No.: 09/860,716

(22) Filed: May 21, 2001

(51) Int. Cl. G01D 21/00; B43L 7/10

(52) U.S. Cl. 33/194; 33/645; 33/464

(57) ABSTRACT

An apparatus used to align door jambs and like structures. A base member comprises a substantially longitudinal section through which a channel is formed in the top surface thereof, one end extending into a first jamb spreader. A first extension member is slidably coupled within the channel of the base member, the extended end of the extension member depending into a second jamb spreader. A second extension member is slidably coupled within the channel of the base member opposite the first extension member, the end opposing the second jamb spreader depending into a third jamb spreader. The jamb spreader of the first and second extension members include horizontal and vertical leveling members. By positioning the opposed jamb spreaders against the opposed door jambs or surfaces, the alignment of the door jambs and door frame may be determined to be in square and plumb alignment.

### BACKGROUND OF THE DISCLOSURE

1. Field of the Invention

The present invention generally relates to apparatus used for the alignment of door frames and the like and, more particularly, to apparatus used to determine whether the elements of a door frame are square and plumb.

2. Prior Art

It has long been recognized that the proper installation of a door frame requires that the opposing door jambs of the door frame be separated by predetermined equal distances during installation of the door frame. When installing a door frame, if the door frame is not properly aligned, the door will not hang properly. For example, if the distance between the vertical door jambs at the base thereof exceeds the distance between the door jambs at the top, the door will be biased toward the floor. Under the opposite circumstances, the door will not close properly.

The prior art discloses numerous devices which seek to permit a user to determine whether the elements of a door frame are square. One of the devices disclosed in the prior art includes a pair of elongated, extension members having door jamb spreaders integral with the extension members at opposite ends thereof. Although the device disclosed by the prior art can be used to determine the distance between opposing door jambs, it cannot be used to check the complete alignment of the door frame, including whether it is plumb with respect to the supporting surface or floor. In addition, since the top of a typical door frame is generally spaced approximately 84 inches from the bottom, the use of only a pair of extension members is extremely cumbersome because of size. Another device disclosed by the prior art comprises a pair of extension members having longitudinal elements which are slidably coupled to one another through the use of conventional fasteners. As with the other devices disclosed in the prior art, the distance between opposed door jambs may be determined, but the square and plumb of the door frame cannot be insured.

The present invention resolves those problems inherent in the devices disclosed by the prior art. The present invention employs three engageable members. These include a base member and first and second extension members. The use of one or both extension members depends upon whether the present invention is being used for vertical or horizontal alignment of a door jamb.

The base member includes a longitudinal section into which a channel is disposed. One end of the base member depends into a door jamb spreader which is adapted to engage a door jamb. The first extension member includes a longitudinal section which is adapted to be slidably engaged within the channel of the base member. First extension member depends into a jamb spreader which is adapted to be opposite the jamb spreader of the base member.

Where the vertical dimension of a door frame is to be aligned, the second extension member is used. The second extension member comprises a longitudinal section which slidably disposed within the channel of the base member opposite the first extension member. The second extension member includes a jamb spreader which is adapted to be opposite that of the jamb spreader of the first extension member. To insure the door frame is square and plumb, horizontal and vertical leveling means are incorporated into the jamb spreaders of the first and second extension members. The opposed jamb spreaders are urged against the opposed door jamb surfaces. When in place, the present invention will determine whether the joints between the horizontal and vertical door jambs are square and, whether the head frame of the door jamb is level and the door jamb is plumb with respect to the supporting surface.

### SUMMARY OF THE INVENTION

The present invention comprises an apparatus to aid in the installation of and to insure that a door jamb, or like structure, is aligned, square and plumb. The present invention comprises a base member and first and second cooperating extension members. The base member comprises an elongated, linear section which depends at one end thereof into a first jamb spreader. A channel is disposed into the top surface of the base member, the channel extending through the elongated section and the depending jamb spreader.

A first extension member comprises an elongated, linear section, one end thereof depending into a second jamb spreader. The elongated section of the first extension member is adapted to be slidably and securely disposed within the channel of the base member. The second jamb spreader incorporates therein leveling means for determining the level of surfaces parallel and perpendicular to the longitudinal axis of the base member and the first extension member. The second extension member is comprised of an elongated linear section which is adapted to be slidably and securely received within the channel of the base member. The end of the second extension member is adapted to be opposite the second jamb spreader and depends into a third jamb spreader. Leveling means are incorporated into the third jamb spreader to determine the alignment of surfaces parallel and perpendicular to the longitudinal axis of the base member and second extension member. The base member and the first and second extension members include measurement means disposed on the top surfaces of each to indicate the distance between the extended jamb spreaders.

In order to determine whether a door jamb or the like is square and plumb and the distance between opposed door jambs, the opposed jamb spreaders are extended by sliding one or both extension members within the channel of the base member until the opposed jamb spreaders are in engagement with the opposed door jambs. The measuring means will indicate the distance between the opposed door jambs. The leveling means will permit a determination regarding whether the frame jamb is square and plumb and whether the frame head is level and frame corners square.

It is therefore an objection of the present invention to provide an improved apparatus for the alignment of door jambs and the like.

It is another object of the present invention to provide a self contained apparatus to determine whether a door frame is square and plumb.

It is still yet another object of the present invention to provide an alignment apparatus which may determine the perpendicular relationship of the horizontal and vertical elements of a door jamb.

It is still yet another object of the present invention to provide an alignment apparatus which is simple and inexpensive to fabricate.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### BRIEF DESCRIPTION OF THE DRAWINGS

FIG. 1 is a front perspective view of the present invention door jamb alignment apparatus illustrating the first and second extension members slidably coupled to the base member.

FIG. 2 is a cross-sectional view of the coupled base member and second extension member shown in FIG. 1 taken through line 2-2 thereof.

FIG. 3 is a top plan view of the base member shown in FIG. 1.

FIG. 4 is a cross-sectional view of the base member shown in FIG. 3 taken through line 4-4 of FIG. 3.

FIG. 5 is a top plan view of the extension members shown in FIG. 1.

FIG. 6 is a cross-sectional view of the first extension member shown in FIG. 5 taken through line 6-6 of FIG. 5.

FIG. 7 is a top plan view of coupled base member and first extension member illustrated in the extended position with the jamb spreaders in engagement with vertical door jambs.

FIG. 8 illustrates the present invention door jamb alignment apparatus in vertical engagement with the door frame head.

### DESCRIPTION OF THE PRESENTLY PREFERRED EMBODIMENT

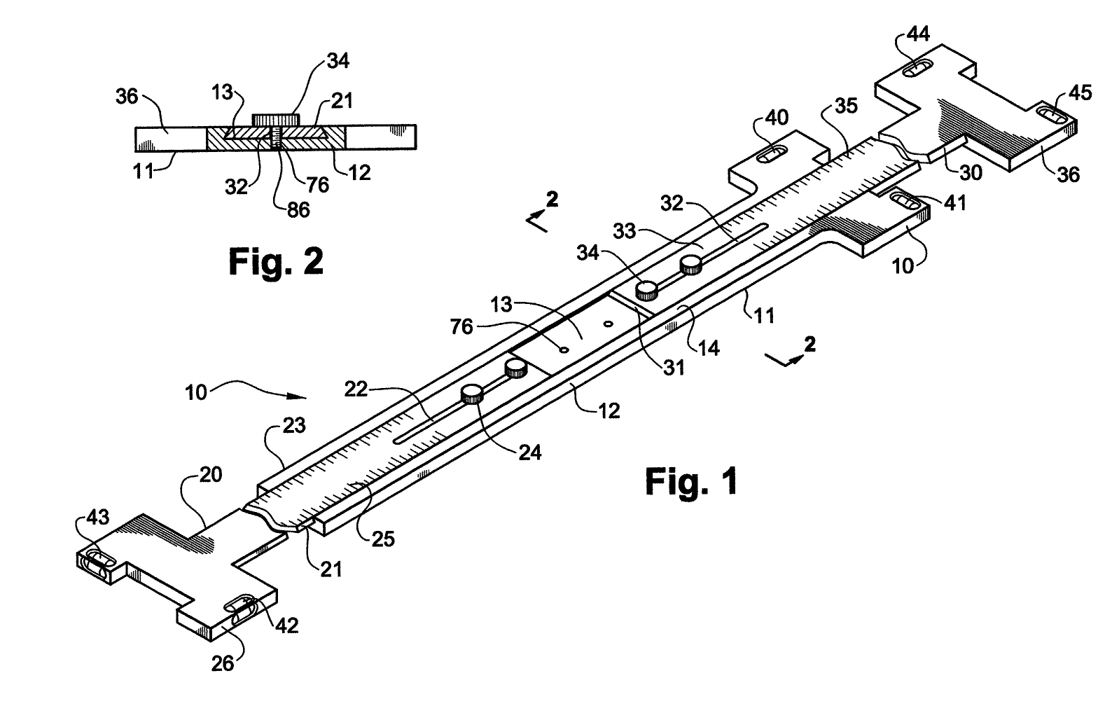

The present invention comprises a tool adapted for use in the installation of door frames of different sizes and to insure that the elements of the door frame are in square and plumb alignment. Although the present invention is described with respect to use with door frames, it is understood the present invention may be used with regard to the alignment of window frames, it is understood the present invention may be used with regard to the alignment of window frames and the like. An understanding of the structure of the present invention may be best gained by reference to FIGS. 1-6, inclusive, wherein the present invention door jamb alignment apparatus is generally designated by the reference numeral 10. A base member 11 comprises a substantially elongated segment 12 having a channel 13 disposed into the top surface 14 of base member 11 along the longitudinal axis thereof. The elongated segment 12 depends into a first jamb spreader 15 which is adapted to be positioned adjacent a door jamb during use of the present invention.

A first extension member 20 comprises an elongated segment 21 which is adapted to be slidably received within channel 13 of base member 11. An elongated aperture 22 is disposed through top surface 23 of elongated segment 21. A first positioning member 24 is adapted to be disposed through elongated aperture 22 and coupled to base member 11 within channel 13. Measurement indicia 25 are disposed along top surface 23 of elongated segment 21 to permit the user to determine the distance between opposed door jambs. Elongated segment 21 depends into second jamb spreader 26 which is adapted to be placed adjacent a door jamb to carry out the objectives of the present invention.

A second extension member 30 comprises an elongated segment 31 which is adapted to be slidably received within channel 13 of base member 11 in opposition to first extension member 20. An elongated aperture 32 is disposed through top surface 33 of along the longitudinal axis of elongated segment 31. A positioning member 34 is adapted to be disposed through elongated aperture 32 and engaged to base member 11 within channel 13. Measurement indicia 35 are disposed along the top surface 33 of elongated segment 31 to allow the user of the present invention to determine the distance between two opposed door jambs. In the same manner as described with respect to first extension member 20, elongated segment 31 depends into third jamb spreader 36.

As will be described in detail hereinbelow, the present invention is used to determine the distance between opposed door jambs and to determine whether door jambs are properly aligned, square and plumb. To meet these objectives, bubble-levelers 40 and 41 are coupled to first jamb spreader 15 both parallel and perpendicular to the longitudinal axis of base member 11. In a like manner, bubble-levelers 42 and 43 are coupled to second jamb spreader 26 parallel and perpendicular to the longitudinal axis of first extension member and bubble-levelers 44 and 45 are coupled to third jamb spreader 36 parallel and perpendicular to the longitudinal axis of second extension member 30.

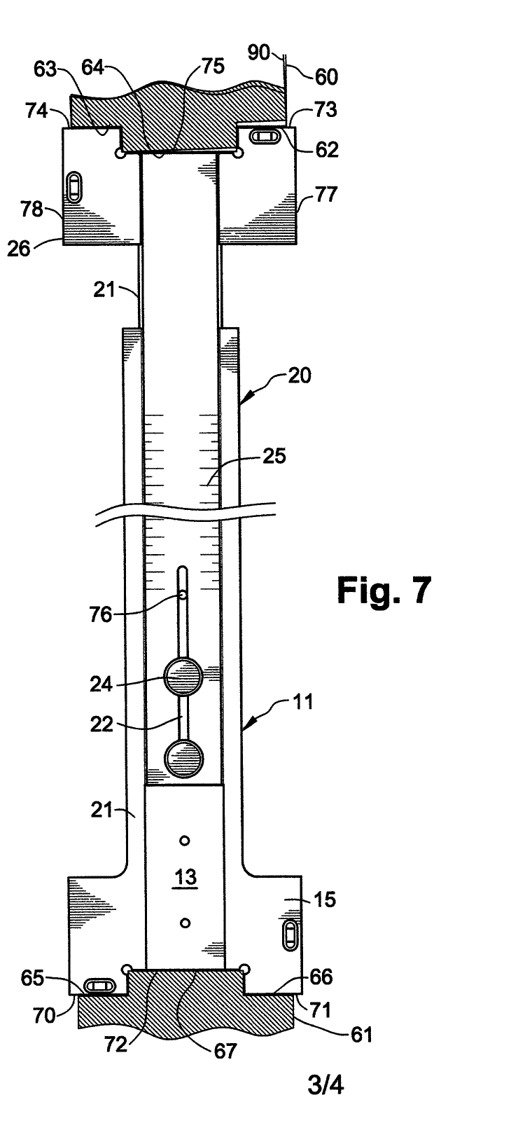

FIG. 7 illustrates the present invention 10 disposed between opposed vertical door jambs 60 and 61. The relevant structural elements of door jamb 60 are door rabbets 62 and 63 which are separated by the soffit 64 against which a mounted door will be seated. In a like manner, the relevant structural elements of door jamb 61 are door rabbets 65 and 66 which are separated by soffit 67. If door jambs 60 and 61 are not properly aligned, the door will not seat properly against the door jambs 60 and 61.

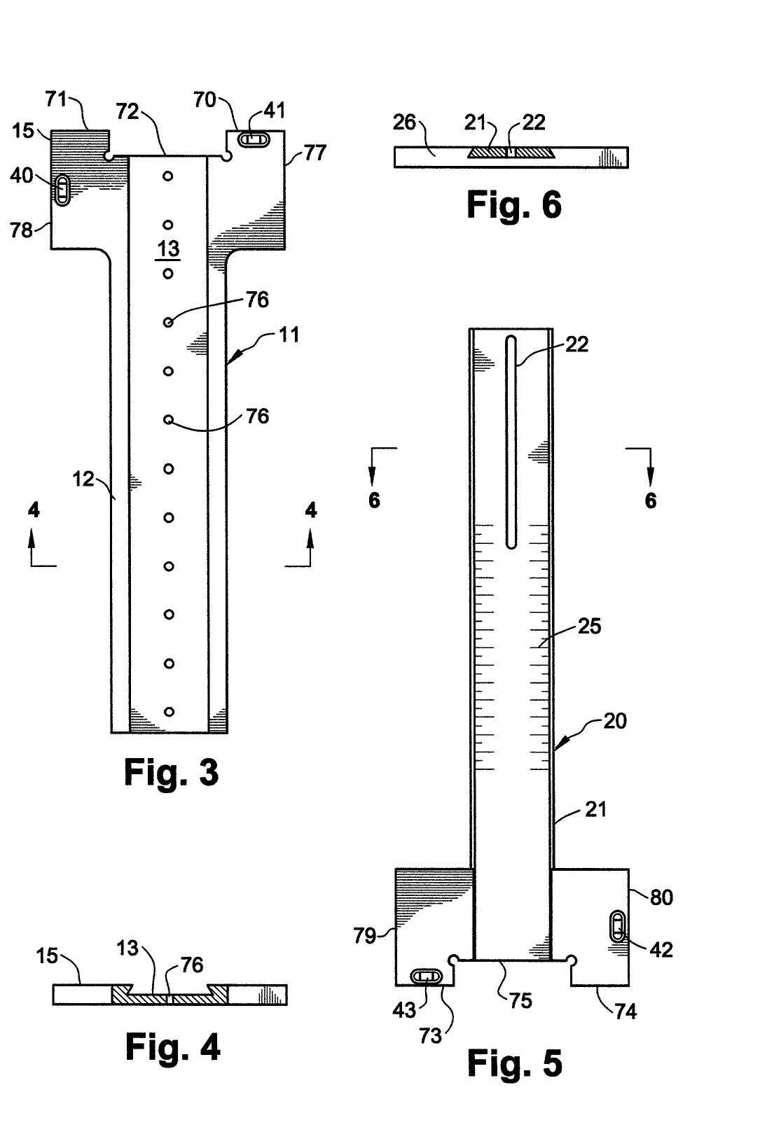

Under typical circumstances, the horizontal alignment of opposed door jambs may be determined solely using the slidably engaged base member 11 and first extension member 20. First extension member 20 is slidably moved within channel 13 of base member 11 to adjust to the distance between door jambs 60 and 61. As shown in FIG. 7, first and second jamb spreaders 15 and 26 are disposed adjacent door jambs 61 and 60 respectively. As can be seen in FIG. 3, the first jamb spreader comprises a pair of aligned surfaces 70 and 71 which are separated by recess 72. Aligned surfaces 70 and 71 are adapted to be disposed adjacent door rabbets 65 and 66, respectively. Recess 72 is adapted to be disposed adjacent soffit 67. An objective of the present invention is to determine whether the joints of the door jamb header and door jamb are perpendicular to each other, i.e., square. To accomplish this objective, the lateral surfaces 77 and 78 of first jamb spreader 15 are parallel to each other and to the longitudinal axis of base member 12, and are perpendicular to aligned surfaces 70 and 71, respectively.

As shown in FIG. 5, second jamb spreader 26 includes aligned surfaces 73 and 74 separated by recess 75. As described with respect to base member 11, aligned surfaces 73 and 74 are adapted to be disposed adjacent door rabbets 62 and 63, recess 75 being adapted to be disposed adjacent soffit 64. As was described with respect to base member 15, second jamb spreader 26 is used to determine whether a door jamb is square. To accomplish this objective, the lateral surfaces 79, 80 of second jamb spreader 26 are parallel to each other and to the lateral axis of the first extension member 20 and are perpendicular to aligned surfaces 73 and 74, respectively.

To secure first extension member 20 to base member 11, position fastener 24 is secured within one of the receiving apertures 85 disposed into the surface of channel 13. In the preferred form of the present invention, positioning members 24 and 34 (FIG. 2) include threaded shafts 86. The receiving apertures 85 are provided with mating, threaded surfaces.

The present invention provides the ability to determine whether a door jamb is aligned, plumb and square. As shown in FIG. 7, a misaligned door jamb 60 is identified by the reference numeral 90. This is evidenced by the angular separation between the aligned surfaces 73 and 74 and the respective door rabbets 62 and 63, respectively. When compared to the misaligned door frame represented by reference numeral 90, a properly aligned door jamb 61 provides a uniform, adjacent relationship between door rabbets 65 and 66 and the adjacent aligned surfaces 70 and 71, respectively.

In addition to determining the alignment of door jamb 60 and 61, FIG. 7 illustrates use of the present invention to determine the actual separation between door jamb 60 and 61. As stated hereinabove, elongated segment 21 is slidably disposed within channel 13 of base member 11. Positioning member 24 is disposed within elongated aperture 22 and is removeably secured to base member 11 through its engagement to a receiving aperture 85. By slidably positioning first extension member 20 within base member 11 to provide engagement between recesses 72 and 75 and door jamb 61 and 60 respectively, the distance between the door jamb 60 and 61 can be determined through the positioning of measurement indicia 25. By performing the same procedure at both the upper and lower portions of the door frame, the horizontal distance between the opposed door jambs 60 and 61 can be properly equalized.

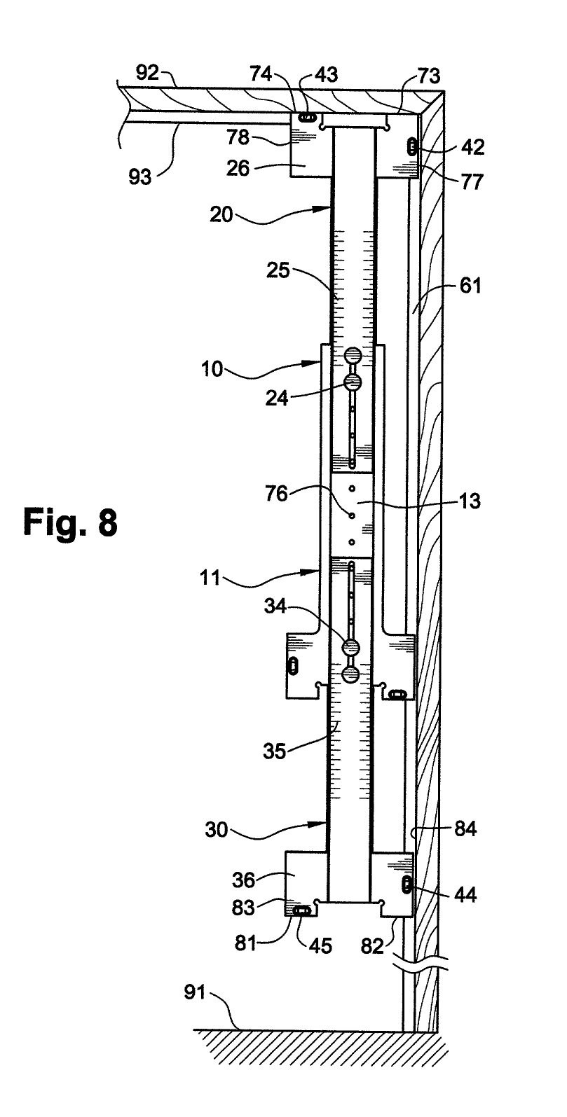

FIG. 8 illustrates use of the present invention to determine whether a door frame is plumb and square. As shown in FIG. 8, door jamb 61 will be plumb if it is vertically aligned with respect to surface 91. Although door jamb 60 is not shown in FIG. 8, it is understood the principles described apply equally to door jamb 60. Door frame 92 will be deemed to be square if door head 93 is perpendicular to door jamb 61.

The present invention can be used with only base member 11 and first extension member 20 where the distances are appropriate. However, where the present invention apparatus 10 is being used to analyze the vertical alignment of a door frame or the horizontal alignment of door frames having oversized openings, second extension member 30 is used in the manner shown in FIG. 8. First extension member 20 is slidably positioned within channel 13 and positioning member 24 secured to a receiving aperture 76 securing the position of first extension member 20 relative to base member 11. In a typical door frame, the top of door head 93 is spaced approximately 84 inches from surface 91. With second jamb spreader 26 adjacent the top of door head 93, second extension member 30 extends downwardly toward adjacent surface 91. Positioning member 34 is engaged to a receiving aperture 76 and tightened until second extension member 30 is secured relative to base member 11.

As described with respect to FIG. 7, surfaces 73 and 74 of jamb spreader 26 are linearly aligned with each other and are perpendicular to lateral sections 77 and 78. In a like manner, surfaces 81 and 82 of second extension member 30 are linearly aligned with each other and are perpendicular to lateral surfaces 83 and 84, respectively. Door jamb 61 will be deemed to be square relative to door head 93 and surface 91 by reference to the perpendicular relationship of the surfaces of jamb spreaders 26 and 36 and, most importantly, the horizontal verification of bubble levelers 43 and 45. To verify that door jamb 61 is plumb, the present invention apparatus 10 as shown in FIG. 8 is rotated 90°. Bubble leveler 43 will verify whether door jamb 61 is vertical relative to surface 91 or is angularly deflected in either direction.

It can therefore be seen the present invention provides an improved apparatus for use in mounting and aligning door frames and the like and insuring the structures are aligned, square and plumb.

I claim:

1. An apparatus for aiding in the installation of a door frame having spaced door jambs upon a supporting surface comprising:
(a) an elongated base member having a uniform, securing channel disposed therein and depending into a first door jamb spreader adapted to be placed adjacent one of the door jambs;
(b) at least one extension member having an elongated section adapted to be slidably secured within the channel of said base member, said extension member depending into a second jamb spreader opposed to and spaced from the first jamb spreader, said second jamb spreader being adapted to be placed adjacent the spaced door jamb;
(c) leveling means coupled to said first jamb spreader for positioning said apparatus vertical relative to the supporting surface; and
(d) measurement means disposed upon said extension member for indicating the distance by which the first and second jamb spreaders are spaced from each other.

2. An apparatus for aiding in the installation of a door frame having spaced door jambs as defined in claim 1 wherein said base member includes an elongated, linear member into which is the channel is disposed through the top surface thereof, said channel being uniformly disposed along the longitudinal axis of the elongated member, the width of said channel being defined by parallel side walls, the distance between the side walls at the top surface of the elongated section being less than that at the bottom of the side walls.

3. An apparatus for aiding in the installation of a door frame as defined in claim 2 wherein said extension member includes a linear, elongated member having a top and bottom surface and parallel side walls, the distance between the top of the side walls being less than at the bottom of the side walls.

4. An apparatus for aiding in the installation of a door frame as defined in claim 3 wherein said base member includes a plurality of receiving apertures uniformly disposed along the longitudinal axis of the channel, an elongated aperture being disposed through the elongated member of said extension member in alignment with said receiving apertures, and further including securing means adapted to be disposed through the elongated aperture into a receiving aperture for securing the position of said extension member relative to the base member.

5. An apparatus for aiding in the installation of a door frame as defined in claim 1 further including a second extension member having an elongated section adapted to be slidably secured within the channel of said base member in opposition to said first extension member, said second extension member depending into a third jamb spreader opposed to and spaced from the second jamb spreader, said third jamb spreader being adapted to be placed adjacent the spaced door jamb.

6. An apparatus for aiding in the installation of a door frame as defined in claim 5 including measurement means disposed upon said second extension member for indicating the distance by which the second and third jamb spreaders are spaced from each other.

7. An apparatus for aiding in the installation of a door frame as defined in claim 6 including leveling means coupled to the second and third jamb spreaders for positioning said apparatus vertical relative to the supporting surface.
